(19) United States
(12) Patent Application Publication
(10) Pub. No.: US 2021/0317935 A1
(43) Pub. Date: Oct. 14, 2021

(54) Profile Clamp

(71) Applicant: NORMA Germany GmbH, Maintal (DE)

(72) Inventors: Fabio Ghirardi, Hanau (DE); Viktor Stoll, Großkrotzenburg (DE); Gerrit von Breitenbach, Karlstein (DE); Manuel Baudoin, Newbury, Berkshire (GB); Brian Geese, Lake Orion, MI (US)

(21) Appl. No.: 17/259,667

(22) PCT Filed: Jun. 18, 2019
(86) PCT No.: PCT/EP2019/066102

§ 371 Date: Jan. 12, 2021

(30) Foreign Application Priority Data
Jul. 12, 2018 (DE) 10 2018 116 959.0

(51) Int. Cl. F16L 23/04; F16B 2/06

(52) U.S. Cl. CPC F16L 23/04; F16B 2/06

(57) ABSTRACT

A profile clamp has a clamp strip that has a base with flanks on both sides. A flank angle α is enclosed between the flanks and a clamping head is arranged at each end of the clamp strip. For even stress distribution, the flank angle α decreases from a clamping head of the clamp strip up to a region diametrically opposite the clamping heads, and then increases again from that region to the other clamping head.

### INTRODUCTION

The disclosure concerns a profile clamp with a clamp strip which has a base with flanks on both sides, wherein a flank angle is enclosed between the flanks, and a clamping head is arranged at each end of the clamp strip, wherein the clamping heads are connected together via a clamping device.

Profile clamps are often used to connect abutting pipe ends together in axially rigid fashion. Radially outwardly protruding flanges are provided on the pipe ends, and the profile clamp is placed thereon. Via a corresponding profile of the clamp strip of the profile clamp, which is usually V-shaped or U-shaped, when the profile clamp is tightened, radial and axial clamping forces are produced, whereby the pipe ends are pressed together axially. This gives a pressure-resistant connection.

One area of use of profile clamps is in the motor vehicle sector, for example to secure exhaust gas pipes, but also other pressurized pipe connections in the region of the engine bay. The profile clamps should typically therefore produce reliably adequate clamping forces over a relatively wide temperature range and for long periods. Since engines of motor vehicles are becoming ever more compact and, at the same time, ever higher emission limits should be observed, the temperature load on individual components rises and hence also on the profile clamps to be used.

In order to ensure reliability, firstly the application of relatively high clamping forces is commonly necessary, and secondly these should be distributed as evenly as possible over the profile clamp. In this way, the risk of clamping forces diminishing because of temperature fluctuations can be kept low.

### SUMMARY

The disclosure, per an embodiment, provides a profile clamp which allows as even a stress distribution as possible. Furthermore, high clamping forces are produced.

In a profile clamp with a clamp strip which has a base with flanks on both sides, wherein a flank angle is enclosed between the flanks and a clamping head is arranged at each end of the clamp strip, wherein the clamping heads can be connected together via a clamping device, it is provided according to an embodiment of the disclosure that the flank angle decreases from one clamping head of the clamp strip up to a region diametrically opposite the clamping heads, and then increases again from that region up to the other clamping head.

With this embodiment, the stress distribution is better and more even. This embodiment exploits the fact that on tightening of the profile clamp, a region of the clamp strip adjacent to the clamping heads moves more greatly, relative to the flanges of the pipe ends, than the region arranged diametrically opposite the clamping heads. The friction occurring during this relative movement between the clamp strip and the flanges has a greater influence on the clamping forces in the regions with greater movement than in the regions with smaller or no movement. This is taken into account according to the disclosure in that the flank angle diminishes starting from the clamping head, i.e. the flanks become steeper. In the region of the steeper flanks, these therefore bear against the flange earlier than in the region of flatter flanks, which leads to an earlier introduction of force in the region of the steeper flanks. As a whole therefore, not only can higher clamping forces be applied, but the stress distribution is more even, whereby also length changes caused by temperature fluctuations can be better compensated.

According to an embodiment of the disclosure, the flank angle changes continuously, in particular linearly or quadratically. This continuous change in flank angle avoids stress peaks and achieves a more even stress distribution.

In an embodiment, the clamp strip is divided into at least two parts by cutouts in the flanks, wherein the parts are connected together integrally or via a bridge element. This division of the clamp strip gives the profile clamp a relatively great flexibility, so that it can be opened wide enough to be able to be placed easily on the flange of the pipe ends. In a two-piece clamp strip, the cutouts are usually diametrically opposite the clamping heads.

Per an embodiment, the clamp strip is divided into at least three parts, wherein the flank angle in at least one of the parts differs from the flank angle in the other parts. Thus for example the two parts adjacent to the clamping heads have a same flatter flank angle than the third part of the clamp strip which connects these two parts. With such a design, the parts can be preconfigured relatively easily and then connected together via bridge elements.

Per an embodiment, the clamping heads are formed integrally with the clamp strip. The clamping heads are thus produced by bending the ends of the clamp strip radially outward, and can thus transfer relatively high clamping forces from the clamping device onto the clamp strip.

### BRIEF DESCRIPTION OF THE FIGURES

Further features, details and advantages of the disclosure arise from the wording of the claims and from the following description of exemplary embodiments with reference to the drawings. The drawings show:

FIG. 1 a side view of a profile clamp, and

FIG. 2 a cross-section of a clamp strip.

### DETAILED DESCRIPTION

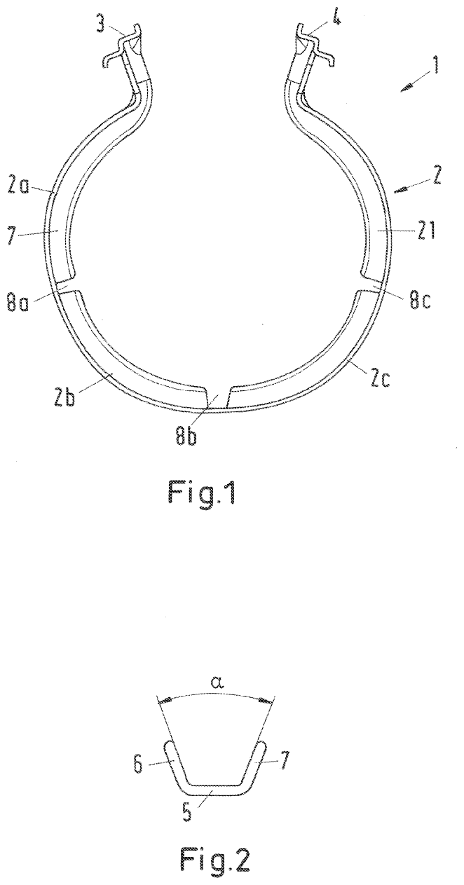

FIG. 1 shows a profile clamp 1 having a clamp strip 2 which, in this embodiment, comprises four parts 2a, 2b, 2c, 2d. At the end of the clamp strip 2, clamping heads 3, 4 are formed which can be connected together by a clamping device (not shown), in particular via a clamping screw. By tightening this clamping device, the clamping heads 3, 4 are moved towards each other, reducing the diameter of the profile clamp 1.

The clamp strip 2 has a substantially V-shaped profile with a base 5 and flanks 6, 7 on both sides at its axial edges, between which a flank angle α is formed (FIG. 2). This flank angle α changes continuously over the circumference of the profile clamp. Starting in the region of the clamping heads 3, 4, this flank angle α diminishes such that the flanks stand more steeply diametrically opposite the clamping heads than in regions adjacent to the clamping heads 3, 4.

To achieve adequate flexibility of the clamp strap 2, cutouts 8a, 8b, 8c are formed in the flanks between the parts 2a to 2d. These cutouts 8a, 8b, 8c can be bridged via bridge elements or via an integral continuous base 5 of the clamp strap 2. Thus the cutouts 8a, 8b, 8c with the bridge elements or the base form material-fit joints, via which the profile clamp 1 can be widened.

The disclosure is not restricted to one of the embodiments described above, but may be modified in many ways. Thus the clamp strip may in particular consist of a different number of parts, for example of two parts which are connected together via a material-fit joint. Each part of the clamp strip may have a constant flank angle, as an alternative to a continuously increasing or decreasing flank angle.

All features and advantages arising from the claims, description and drawing, including design details, spatial arrangements and method steps, may be essential to the invention both alone and in various combinations.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE SIGNS

1 Profile clamp
2 Clamp strip
2a Part
2b Part
2c Part
2d Part
3 Clamping head
4 Clamping head
5 Base
6 Flank
7 Flank
8a Cutout
8b Cutout
8c Cutout

1. A profile clamp comprising a clamp strip which has a base with flanks on both sides, wherein a flank angle α is enclosed between the flanks and a clamping head is arranged at each end of the clamp strip, wherein the clamping heads can be connected together via a clamping device, wherein the flank angle α decreases from one clamping head of the clamp strip up to a region diametrically opposite the clamping heads, and then increases again from that region up to the other clamping head.

2. The profile clamp as claimed in claim 1, wherein the flank angle α changes continuously. 0

3. The profile clamp as claimed in claim 1, wherein the clamp strip is divided into at least two parts by cutouts in the flanks, wherein the parts are connected together integrally via the base or via a bridge element.

4. The profile clamp as claimed in claim 2, wherein the clamp strip is divided into at least three parts, wherein the flank angle α in at least one of the parts differs from the flank angle α in the other parts.

5. The profile clamp as claimed in claim 1, wherein the clamping heads are formed integrally with the clamp strip.

6. The profile clamp as claimed in claim 1, wherein the flank angle α changes linearly.

7. The profile clamp as claimed in claim 1, wherein the flank angle α changes quadratically.

8. The profile clamp as claimed in claim 1, wherein the clamp strip is divided into at least two parts by cutouts in the flanks, wherein the parts are connected together integrally via a bridge element.
